(19) United States
(12) Patent Application Publication
(10) Pub. No.: US 2020/0080596 A1
(43) Pub. Date: Mar. 12, 2020

(54) BEARING PROTECTOR

(71) Applicant: Evapco, Inc., Taneytown, MD (US)

(72) Inventor: Davey Joe Vadder, Westminster, MD (US)

(21) Appl. No.: 16/539,118

(22) Filed: Aug. 13, 2019

Related U.S. Application Data
(60) Provisional application No. 62/718,234, filed on Aug. 13, 2018.

(51) Int. Cl. F16C 33/76; F16C 43/04; F16C 35/04

(52) U.S. Cl. CPC F16C 33/76; F16C 35/047; F16C 43/045

(57) ABSTRACT

A split bearing protector with a flexible design that adds improved moisture protection to a bearing and can be installed without removing the bearing from the machine in which it is installed.

### FIELD OF THE INVENTION

This invention relates to bearing seals.

### BACKGROUND OF THE INVENTION

Ball bearings are commonly used to support vertical shafts for air moving fans in cooling equipment like cooling towers. When these bearings are used in service outdoors, especially in a saturated cooling tower environment, they are subject to water condensation and subsequent infiltration past the seal which leads to premature bearing lubrication failure, corrosion, and ultimately mechanical failure. Bearing “slingers” and “flingers” are commonly used in these applications to reduce water infiltration into the bearings. By way of example, FIG. 1 shows a bearing connected to shaft which does not have a free end and in which a prior art rubber bearing “flinger” is friction fit around the shaft. FIG. 2 shows a prior art locking collar integrated bearing “slinger” in which the slinger is integrated to the bearing locking collar and requires a special bearing housing. FIG. 3 shows a prior art single piece locking collar mounted “slinger” of prior art.

But these prior art bearing protectors have had limited success. None of the prior art bearing protectors are easily installed or replaced on existing equipment, and many designs fail to adequately protect the bearing from water condensation and only serve to reduce water ingress from falling rain. Other designs are only compatible with one type or a special type of bearing.

### SUMMARY OF THE INVENTION

This invention serves to solve the problems of the prior art by providing a close-fitting through-shaft secondary protective grease seal and be installed on multiple common bearing brands without removing the shaft from the bearing.

According to various embodiments of the invention, a bearing protector is presented having a generally radially or annular shaped housing that is configured to fit snugly around the shaft and the bearing assembly (i.e., around locking collar of the bearing and around the outer race of the bearing), but which, when fastened to the bearing assembly and shaft, creates a space between the bearing assembly and the bearing protector which space may be filled with protective grease. The annular housing is not continuous, but is characterized by a first and second end which abut each other when fastened to the shaft and bearing assembly. The annular housing is sufficiently flexible so that its annular shape can be opened, for example by spreading or twisting, separating the first and second ends, so that it can be placed around the shaft and the bearing without removing the shaft from the bearing. Once the protector has been fitted about the bearing and the shaft and allowed to relax, the first and second ends of the protector will abut or nearly abut one-another, and may be fixed tightly to one-another by snap fit, screw, nut and bolt, or any other fixation method and/or device.

According to another embodiment of the invention, a bearing protector is formed by a radial cup-like structure whose internal diameter closely matches the bearing locking collar or inner race extension and fits over and is attached to the bearing locking collar, extended inner race, shaft, or combinations thereof. This cup-like structure radiates down and outward toward and close to the bearing outer race. A cavity is formed between the bearing face and this structure, or bearing protector. This cavity receives grease through the bearing primary seal which is located on the face of the bearing. This cavity is filled with grease expelled from the primary bearing seal and displaces water and/or contaminants that would normally be in contact with the primary bearing seal. The bearing protector is “slit” down one side, enabling it to be deformed into an open position to be placed on a shaft laterally without access to the end of the shaft. The protector may be fastened to the bearing locking collar or extended inner race by friction, by screw, but bolt and nut, by snap fit, or by any known fastening means.

According to various embodiments of the invention, the bearing protector may be manufactured from Acrylonitrile styrene acrylate (“ASA”), making the product suitable for 3D printing in addition to other manufacturing methods including injection molding. The foregoing is not intended to limit the invention to any particular material or method of manufacture, provided that the product has sufficient flexibility to be opened around a shaft for installation yet be sufficiently firm to maintain shape and performance following installation.

### DESCRIPTION OF THE DRAWINGS

The detailed description of the preferred embodiments of the present invention refers to the attached drawings, wherein:

FIG. 1 shows a prior art rubber bearing “flinger” in a vertical shaft axial fan cooling tower.

FIG. 2 shows a prior art locking collar integrated bearing “slinger.”

FIG. 3 shows a prior art single piece locking collar mounted “slinger.”

FIG. 4 shows a perspective view of a bearing protector according to an embodiment of the invention.

FIG. 5 shows a first step in a method for installation of a bearing protector according to an embodiment of the invention by deforming and opening the slit construction.

FIG. 6 shows a second step in a method for the installation of a bearing protector according to an embodiment of the invention.

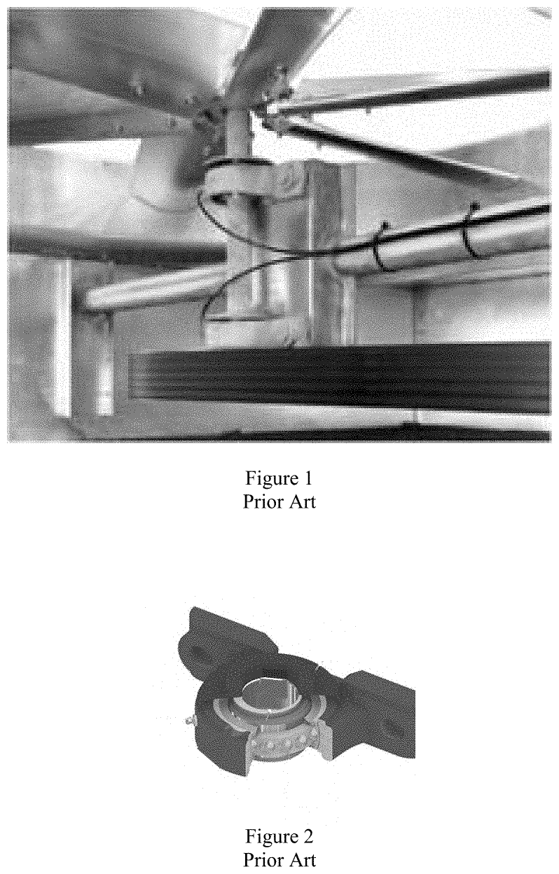

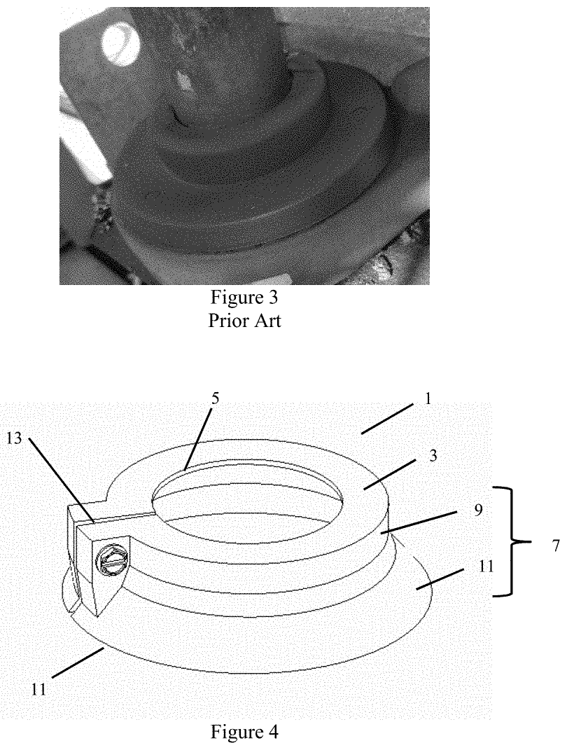

Features in the attached drawings are numbered with the following reference numerals:

1 Bearing Protector
3 Front Face
5 Shaft Contacting Surface
7 Side Face
9 Locking Collar Portion
11 Flange Portion
13 Outer Race Contact Surface
15 Slit/Opening
17 First End
19 Second End

### DETAILED DESCRIPTION OF THE PREFERRED EMBODIMENTS

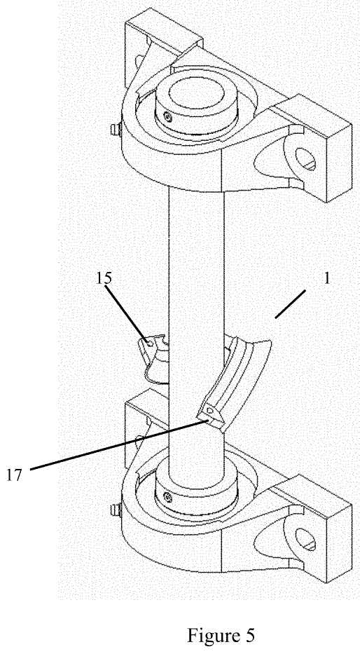

Referring to FIG. 4, bearing protector 1 may be formed by an annular cup-like structure having a front face 3 defining an annular shaft contacting surface 5 and a side face 7, having a locking collar portion 9, a flange portion 11, and an outer race contact surface 11. The inner diameter of the locking collar portion 9 may be configured to closely match the shape and outer diameter of the bearing locking collar, inner race extension, and/or shaft so as to snugly fit over it during installation and use. The flange portion 11 extends down and away from the locking collar portion 9 and terminates at the outer race contact surface 13. The annular shape of the bearing protector 1 is interrupted by a slit or opening 15 bound by first and second ends 17, 19 of the annular bearing protector 1.

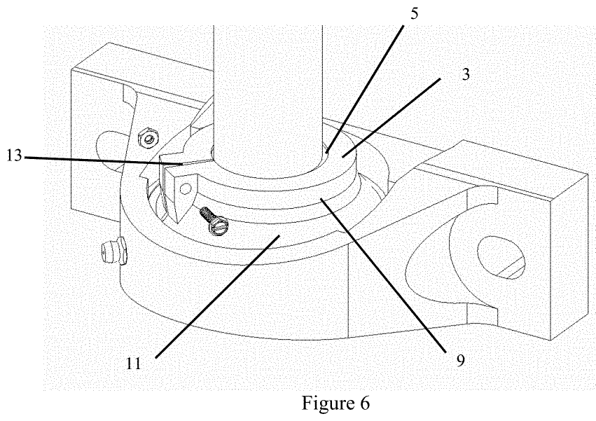

The bearing protector 1 of the invention is sufficiently flexible that it may be twisted so that first and second ends 17, 19 may be separated a distance sufficient to allow passage of the shaft there-between, permitting installation and removal of the bearing protector without separating the bearing from the shaft. See, FIG. 5. Once the protector 1 has been placed around the shaft with the shaft contact surface 5 snugly fitted around the shaft, it may be pressed down over the locking collar and outer race, as shown in FIG. 6.

First and second ends 17, 19 may be securely fixed to one-another by bold and nut, screw, snap fit or other known fixation method or structure. When installed about a shaft and bearing assembly, a cavity is formed between the bearing face and the inside surface of the flange portion 11. This cavity receives grease through the bearing primary seal which is located on the face of the bearing. This cavity is filled with grease expelled from the primary bearing seal and displaces water and/or contaminants that would normally be in contact with the primary bearing seal.

1. A bearing protector comprising
an annular cup-like structure having a front face defining an annular shaft contacting surface, and a side face, said side face comprising a locking collar portion, a flange portion, a shaft portion, and an outer race contact surface,
wherein an inner diameter of the locking collar portion is configured to closely match a shape and outer diameter of a bearing locking collar, inner race extension, shaft or any combination thereof,
wherein the flange portion extends down and away from the locking collar portion and terminates at the outer race contact surface, and
wherein the annular shape of the bearing protector is interrupted by a slit which defines a first end and a second end of the annular cup-like structure.

2. The bearing protector of claim 1, wherein the annular cup-like structure is sufficiently flexible that it may be twisted so that said first and second ends may be displaced from one-another to allow passage of a shaft there-between.

3. The bearing protector of claim 1, further comprising means to securely fix said first end to said second end.

4. A method of protecting a shaft bearing, comprising:
providing an open ring-shaped flexible bearing protector,
deforming said open ring-shaped flexible bearing protector to separate first and second ends of said open ring shaped flexible bearing protector to allow passage of a shaft,
snugly fitting said open-ring shaped flexible bearing protector about said shaft and said shaft bearing, abutting said first and second ends to one-another and affixing them to one-another to prevent movement of said open ring-shaped flexible bearing protector and to prevent leakage of lubricant from an interior thereof.
